(19) United States
(12) Patent Application Publication
(10) Pub. No.: US 2004/0164542 A1
(43) Pub. Date: Aug. 26, 2004

(54) Personal story and event organiser

(76) Inventor: Charles Garvin Crawford, County Down (GB)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/476,657

(22) PCT Filed: May 7, 2002
(86) PCT No.: PCT/GB02/02041

(30) Foreign Application Priority Data
May 4, 2001 (GB) 0110994.1

(51) Int. Cl. B42D 1/08; B42F 5/00

(52) U.S. Cl. 281/22

(57) ABSTRACT

An organiser for personal story and event details comprises a cover (10), a holding mechanism (12) for holding a plurality of similar sized loose-leaf pages consisting of a title page (14), a “keeper of organiser” page (16) and a series of divider pages (18) having title strips (20) to separate different sections. The cover (10) extends over and masks the pages with at least one first pocket (22) provided on the inside of the cover (10) to receive at least one pack (24) of information pages. Each section or space between adjacent divider pages (18) is occupied by one or more of the following pages to be completed or filled in namely, photograph album pages (28), photograph album holders (30), scrapbook pages (32), scrapbook holders (30), index pages (36) of contributions, address book pages (38), pages (40) for use in recording “before and after” event details and/or “afterthought details”, and one or more pages (42) from a group of pages including a “dedication” page, a “sequence of events” page, a “what I remember most” page an index page, a “more about . . . ” page, a “those who will remember”, circle of friends or autograph page, and an additional section of pages designed to facilitate the telling of specific stories as appropriate. The cover (10) has a front part (10A) and a back part (10B) united through a spine part (10C). The holding mechanism (12) is attached to the back part (10B) adjacent to the spine part (10C).

This invention relates to a personal story and event organiser in the form of a loose leaf book. Important events occur in the lives of every person. Many, if not all, such events are not recorded, or recorded in a haphazard and uncoordinated manner. This situation is generally regretted by people after the event when it is generally not possible to recover missing details, for example, from people involved due to them having forgotten details, having moved away and contact has been lost, or having died. This is a disadvantage to most people.

An object of the present invention is to obviate or mitigate this disadvantage.

Accordingly, the present invention is an organiser for personal story and event details comprising a cover, a holding mechanism for holding a plurality of similarly-sized loose-leaf pages consisting of a title page, a ‘keeper of organiser’ page, and a series of divider pages having title strips to separate different sections, the cover at least extending over and masking the pages, at least one first pocket provided on the inside of the cover to receive at least one pack of information pages and, wherein each section or space between adjacent divider pages is occupied by one or more of the following pages to be completed or filled in namely, photograph album pages, photograph album holders, scrapbook pages, scrapbook holders, index pages of contributions, address book pages, pages for use in recording ‘before and after’ event details and/or ‘afterthought details’, and one or more pages from a group of pages including a ‘dedication’ page, a ‘sequence of events’ page, a ‘what I remember most’ page, an index page, a ‘more about . . . ’ page, a ‘those who will remember’, circle of friends or autograph page, and an additional section of pages designed to facilitate the telling of specific stories as appropriate, the organiser being to facilitate the participation of different contributors by completion of one pack of information pages by each contributor, the completed pages being for integration into the organiser.

The cover may have a front part and a back part. Alternatively, the front and back parts may be united through a spine part. The holding mechanism may be attached to the back part adjacent to the spine part.

Preferably, a plurality of pages or holders are provided to hold business or personal cards. One or more pages or holders are beneficially provided to hold greeting cards and/or letters.

Preferably also, the front part of the cover is formed as a photograph frame with an opening having on the inside a second pocket of transparent material to receive a photograph relating to the person whose organiser it is, or to the event(s) about which the contents concern, the second pocket being masked by the first pocket which is of larger areal dimensions.

An embodiment of the present invention will now be described, by way of example with reference to the accompanying drawings, in which:

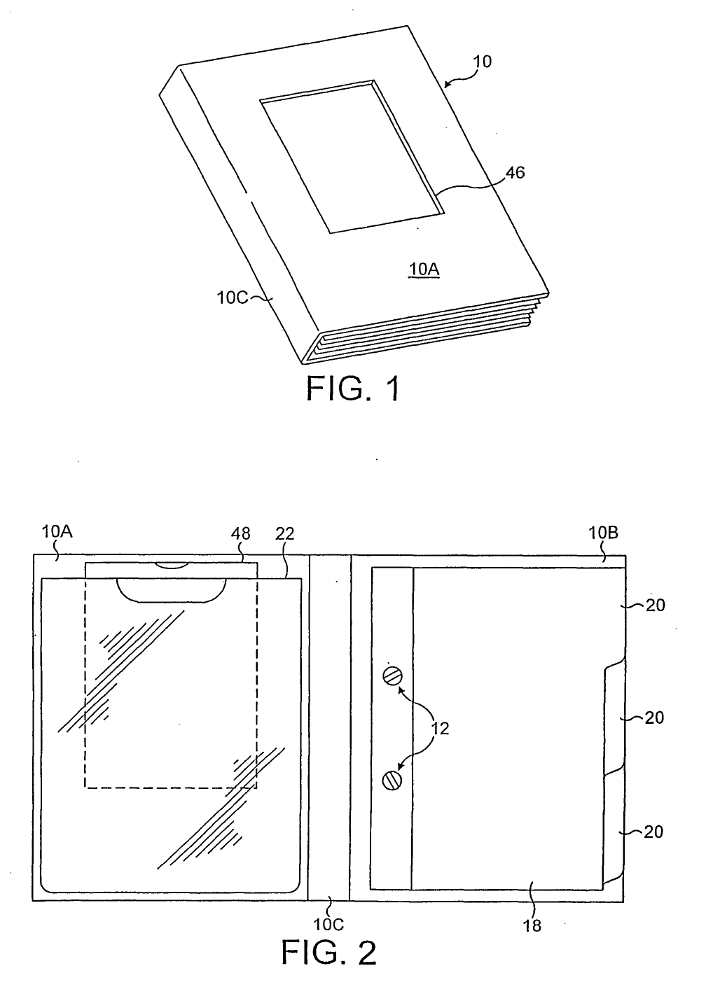

FIG. 1 is a front perspective view of an organiser in a closed position;

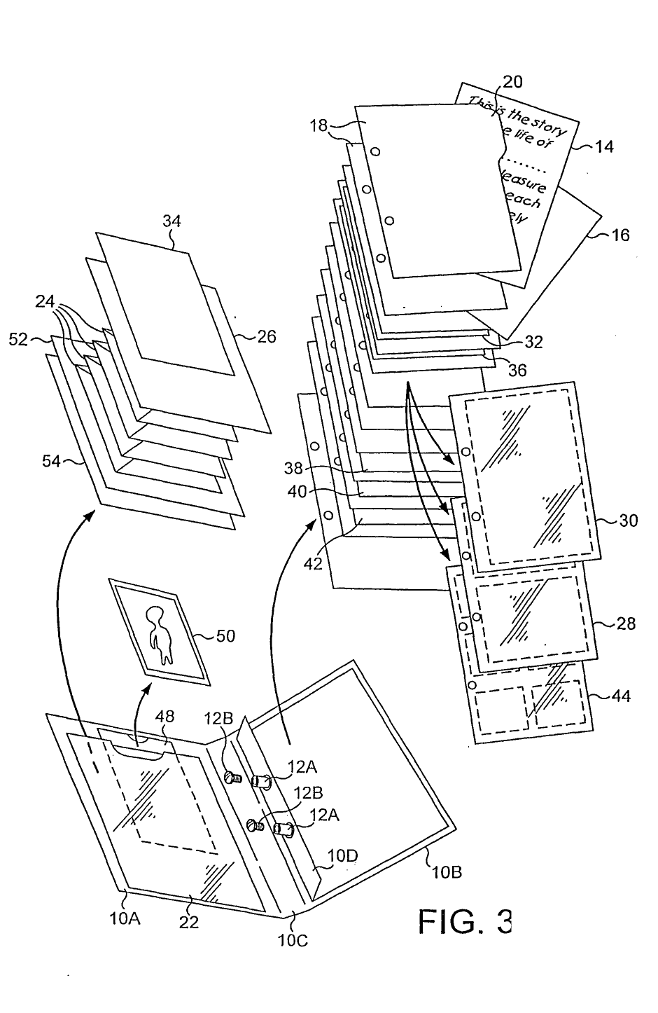

FIG. 2 is a front view of the organiser in an open position; and

FIG. 3 is a perspective view of the organiser showing in exploded detail the page contents thereof.

Referring to the drawings, an organiser for personal story and event details comprises a cover 10, a holding mechanism 12 for holding a plurality of similarly-sized loose-leaf pages consisting of a title page 14, a ‘keeper of organiser’ page 16 and a series of divider pages 18 having title strips 20 to separate different sections. The holding mechanism as shown is two spaced columns 12A having an internal screw thread into which stub screws 12B are screwed into from both ends. The cover 10 has a front part 10A and a back part 10B with the parts 10A, 10B extending over and masking the front and back of the pages. The front and back parts 10A, 10B are united by a spine part 10C and the holding mechanism 12 is secured to the back part 10B adjacent to the spine part 10C through a flap 10D. The front part 10A of the cover 10 has at least one pocket 22 (four shown in the drawing) into which at least one pack 24 of information pages can be inserted in a folded state in an envelope. Each section or space between adjacent divider pages 18 is occupied by one or more of the following pages to be completed or filled in namely, a plurality of photograph album pages 28, a plurality of photograph album holders 30, a plurality of scrapbook pages 32, a plurality of scrapbook holders 30, index pages 36 of contributions, a plurality of address book pages 38, a plurality of pages 40 for use in recording ‘before and after’ event details and/or ‘afterthought’ details. One or more pages 42 from a group of pages are also provided including a ‘dedication’ page, a sequence of events' page, a ‘what I remember most’ page, an index page, a ‘more about . . . ’ page, a ‘those who will remember’, circle of friends or autograph page. There are also pages relating to “story or event specific sections” to be completed. A printed memory jogger 52 is provided listing a series of points/questions serving as an aide-memoire relating to the event being remembered specific to each section of the organiser in the organiser, the jogger being located in the first pocket 22. The organiser is to facilitate the participation of different contributions by the completion of one pack of information pages by each contributor, the completed pages being for integration Into the organiser. The information pages include a ‘What I remember most’ page, a ‘More about’ page and an index page in the same format as those already in the organiser. A folded envelope for return of the completed pages may also be included together with a mini memory jogger specific to the pages contained within the envelope, ie a list of various topics on or about which the contributor may remember an incident or story capable of inclusion into the organiser. The mini-memory jogger has similar information printed on it as the memory jogger 52 but only in relation to the pages in the envelope. The organiser is generally of A5 size.

A plurality of pages or holders 44 are provided to hold business or personal cards. One or more pages or holders 30 are provided to hold greeting cards and/or letters. A ‘Where are they now’ page is provided to keep track of the friends and relatives when they move. The ‘Keeper of Organiser’ page is to honour those who look after and up-date the memory organiser. A ‘Mailing list’ page 26 can be included in the first pocket to list all names and addresses of potential contributors to whom packs have been sent together with date of return of completed pages and any donations of papers, photographs, cuttings etc. The first pocket 22 may also hold an envelope 34 for the first keeper with instructions on how to use the organiser. Guidance notes 54 may also be provided.

The front part 10A of the cover 10 is formed as a photograph frame with an opening 46 having on the inside a second pocket 48 of transparent material to receive a photograph 50 relating to the person whose organiser it is, or to the event(s) about which the contents concern.

In use, an organiser described above is used by a person for himself or herself. Alternatively, a person or group of people can prepare the organiser about a friend (alive or deceased) or an event in which a friend was involved, the completed organiser to be presented to that friend or to relatives of that friend. A keeper of the organiser can be appointed to hand out packs of information sheets and to supervise the collection of completed sheets/pages and to insert them into the relevant spaces between dividers and to insert any articles/newspaper clippings into scrap book pages or holders, photographs into album pages or holders, business or personal cards into relevant pages or holders and cards or letters into the respective pages or holders. Provision can be made to enable contributors to complete information pages on the internet from where they can be downloaded and printed for inclusion in the organiser.

Variations and other modifications can be made without departing from the scope of the invention described above and as claimed hereinafter.

I claim:

1. An organiser for personal story and event details comprising a cover, a holding mechanism for holding a plurality of similarly-sized loose-leaf pages consisting of a title page, a ‘keeper of organise’ page and a series of divider pages having title strips to separate different sections, the cover at least extending over and masking the pages, at least one first pocket being provided on the inside of the cover to receive at least one pack of information pages and wherein each section or space between adjacent divider pages is occupied by one or more of the following pages to be completed or filled namely, photograph album pages, photograph album holders, scrapbook pages, scrapbook holders, index pages of contributions, address book pages, pages for use in recording ‘before and after’ event details and/or ‘afterthought details’, and one or more pages from a group of pages including a ‘dedication’ page, a ‘sequence of events’ page, a ‘what I remember most’ page, an index page, a ‘more about . . . ’ page, a ‘those who will remember’, ‘circle of friends’ or autograph page, and an additional section of pages designed to facilitate the telling of specific stories.

2. An organiser as claimed in claim 1, wherein the cover has a front part and a back part.

3. An organiser as claimed in claim 1, wherein the front and back parts are united through a spine part.

4. An organiser as claimed in claim 1, 2 or 3, wherein the holding mechanism is attached to the back part adjacent to the spine part.

5. A personal story and event organiser as claimed in claim 1 or 4, wherein a plurality of pages or holders are provided to hold business or personal cards.

6. A personal story and event organiser as claimed in claim 1, 4 or 5 wherein one or more pages or holders are provided to hold greeting cards and/or letters.

7. A personal story and event organiser as claimed in any one of the preceding Claims, wherein the front part of the cover is formed as a photograph frame with an opening having on the inside a second pocket of transparent material to receive a photograph relating to the person whose organiser it is, or to the event(s) about which the contents concern, the second pocket being masked by the first pocket which is of larger areal dimensions.

8. An organiser as claimed in claim 4, wherein the mechanism is secured to a flap provided on the back part.

9. An organiser as claimed in any one of claims 4 or 8, wherein the mechanism comprises two colemns having internal screw threads and two stub screws for each column for threaded engagement one into each end of the column.

10. A personal story and event organiser substantially as hereinbefore described with reference to the accompanying drawings.
